(19) United States
(12) Patent Application Publication
(10) Pub. No.: US 2025/0109665 A1
(43) Pub. Date: Apr. 3, 2025

(54) METHOD TO DECARBONIZE OILFIELD OPERATIONS THROUGH SEQUESTRATION OPERATIONS

(71) Applicant: Schlumberger Technology Corporation, Sugar Land, TX (US)

(72) Inventors: Abdul Muqtadir Khan, Sugar Land, TX (US); Melissa Chia Mei Teoh, Paris (FR)

(21) Appl. No.: 18/818,062

(22) Filed: Aug. 28, 2024

Related U.S. Application Data
(60) Provisional application No. 63/586,720, filed on Sep. 29, 2023.

(51) Int. Cl. E21B 41/00; E21B 43/26; E21B 49/08

(52) U.S. Cl. CPC E21B 41/0064; E21B 43/2605; E21B 49/0875; E21B 2200/20

(57) ABSTRACT

Embodiments presented provide for a method to decarbonize hydrocarbon recovery operations. Decarbonization occurs through modifications made to geological stratum to encourage carbon dioxide capture and withholding capabilities.

### CROSS-REFERENCE TO RELATED APPLICATIONS

The current application claims priority to U.S. Provisional Patent Application 63/586,720, filed Sep. 29, 2023, the entirety of which is incorporated by reference.

### FIELD OF THE DISCLOSURE

Aspects of the disclosure relate to efficient use of carbon dioxide. More specifically, aspects of the disclosure relate to different methods of storage of carbon dioxide for use in achieving greenhouse gas sequestration.

### BACKGROUND

Carbon capture utilization and storage, hereinafter “CCUS” involves aspects related to capturing, effective utilization, and storage of carbon dioxide. As there is a need to limit the amount of greenhouse gas emissions, CCUS technologies are becoming more important. CCUS has been a well-recognized and studied field within the petroleum industry.

One aspect of CCUS is to use carbon dioxide in enhanced oil recovery projects. Enhanced oil recovery projects have the objective of maximizing the amount of hydrocarbons recovered from an existing wellbore. Different methods may be used to increase this hydrocarbon recovery, such as thermal treatments, gas treatments, and chemical treatments.

Use of carbon dioxide in a wellbore for maximizing hydrocarbon output is related to gas treatment enhanced oil recovery. In different embodiments, a small amount of carbon dioxide may be incorporated into the gases pumped downhole. These gases cause a differential pressure that forces hydrocarbon out of the geological stratum. In some embodiments, carbon dioxide may be used, in part, as a hydraulic fracturing fluid. In hydraulic fracturing, a fluid is pumped downhole into a geological stratum. High pressure pumps continually pump the fluid into the stratum until the stratum fractures. Operators may continue to pump fluid downhole to further fracture the stratum to a level that is desired by engineers. As part of the fluid pumped downhole, a solid constituent, called a proppant, is also conveyed by the fluid. The proppant may be made of sand, glass, or other solid material. In conventional applications, the proppant is relatively small in size, allowing the proppant to lodge within the open cracks.

Once pressure is removed from the wellbore by deactivating the up-hole pumps, the geological stratum attempts to close the cracks developed by the pressurized fluid. The proppants; however, are lodged into the cracks, thereby limiting such closing. The result is a cracked geological stratum around the wellbore. As the geological stratum is under pressure, but the wellbore is under a lesser pressure, a pressure gradient is established. Mobile hydrocarbons (gas or oil) then tend to travel to the lower pressure areas, thereby allowing hydrocarbons to accumulate within the wellbore. Chemicals may be added to the fluid stream to enhance fluid flows as necessary.

In some applications, carbon dioxide is sequestered for periods of time to prevent the carbon dioxide from entering the atmosphere and becoming a greenhouse gas problem. Storage is done mostly in shallow sandstone water aquifers. While storage may be beneficial to the overall strategy with sequestration, improvements may be made regarding sequestration techniques.

Conventional sequestration has many drawbacks to the industry. Conventional sequestration is prone to leaks, wherein the greenhouse gases may enter the atmosphere, via fissures. Conventional sequestration and specifically the geological stratum used can vastly affect the saturation levels of carbon dioxide within the stratum. For example, it is known that large amounts of variability exist for saturation levels within geological stratum.

There is a need to provide an apparatus and methods that allow for easy sequestration and use of carbon dioxide in order to help industry become carbon neutral. Such apparatus and methods may use technologies that are not complex and are easily understandable by field workers.

There is a further need to provide technologies that are easily adaptable to existing field conditions without significant financial cost.

There is a further need to provide apparatus and methods that do not have the drawbacks discussed above, namely unanticipated loss of carbon dioxide from geological stratum.

There is a still further need to reduce economic costs associated with operations and apparatus described above with conventional tools wherein carbon dioxide cooling methods are eliminated and the need for capital intensive gaseous tanks are minimized.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are; therefore, not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method for carbon dioxide sequestration in a wellsite located within a geological stratum is disclosed. The method may comprise calculating a sealing efficiency of a geological stratum for which the carbon dioxide will be stored. The method may further comprise evaluating relative permeability behavior of carbon dioxide drainage of the geological stratum. The method may further comprise performing a numerical modeling of a reservoir and the geological stratum for at least one of a hydraulic fracturing of the wellsite, a stimulation of the wellsite, and an intervention of the wellsite. The method may further comprise obtaining results that are optimized from the numerical modeling. The method may further comprise, based upon the results from the optimized numerical modeling, conducting the at least one of the hydraulic fracturing of the wellsite, the stimulation of the wellsite, and the intervention of the wellsite.

In another example embodiment of the disclosure, an article of manufacture having a non-volatile memory is disclosed. In this embodiment, the non-volatile memory is configured to store a list of method instructions to be read by a computing device and wherein the computing device is configured to enable actions to control a physical system, the physical system placed at a wellsite to be used for carbon dioxide sequestration within a geological stratum. The method recited may comprise calculating a sealing efficiency of a geological stratum for which the carbon dioxide will be stored and evaluating relative permeability behavior of carbon dioxide behavior of the geological stratum. The method may further comprise performing a numerical modeling of the wellsite and the geological stratum for at least one of a hydraulic fracturing of the wellsite, a stimulation of the wellsite and an intervention of the wellsite. The method may further comprise obtaining results that are optimized from the numerical modeling.

In another example embodiment, a method for carbon dioxide sequestration in a wellsite located within a geological stratum is disclosed. The method may comprise calculating a sealing efficiency of a geological stratum for which the carbon dioxide will be stored. The method may also comprise evaluating at least one of a carbon dioxide drainage and an imbibition behavior of the geological stratum. The method may also comprise performing a numerical modeling of the wellsite and the geological stratum for a hydraulic fracturing of the wellsite. The method may also comprise obtaining results that are optimized from the numerical modeling. The method may also comprise, based upon the results from the optimized numerical modeling, conducting the hydraulic fracturing of the wellsite, wherein carbon dioxide is used in the hydraulic fracturing. The method may also comprise monitoring the wellsite for leakage of carbon dioxide used in the hydraulic fracturing.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted; however, that the appended drawings illustrate only typical embodiments of this disclosure and are; therefore, not be considered limiting of its scope, for the disclosure may admit to other equally effective embodiments.

FIG. 1 is a graph depicting the production of the well immediately after fracturing.

FIG. 2 is a method of carbon dioxide sequestration in one non-limiting example embodiment of the disclosure.

To facilitate understanding, identical reference numerals have been used, where possible, to designate identical elements that are common to the figures (“FIGS.”). It is contemplated that elements disclosed in one embodiment may be beneficially utilized on other embodiments without specific recitation.

### DETAILED DESCRIPTION

In the following, reference is made to embodiments of the disclosure. It should be understood; however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers, and/or sections, these elements, components, regions, layers and/or sections should not be limited by these terms. These terms may be only used to distinguish one element, components, region, layer or section from another region, layer or section. Terms such as “first”, “second”, and other numerical terms, when used herein, do not imply a sequence or order unless clearly indicated by the context. Thus, a first element, component, region, layer, or section discussed herein could be termed a second element, component, region, layer or section without departing from the teachings of the example embodiments.

When an element or layer is referred to as being “on”, “engaged to”, “connected to”, or “coupled to” another element or layer, it may be directly on, engaged, connected, or coupled to the other element or layer, or interleaving elements or layers may be present. In contrast, when an element is referred to as being “directly on”, “directly engaged to”, “directly connected to”, or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood; however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Aspects of the disclosure provide a method to extend the typical CCUS application spectrum. In embodiments, a portion of the fluid used for fracturing, stimulation, or well intervention activities, is replaced by carbon dioxide. The amounts of replacement of the fluids involved may be between trace amounts to one hundred percent fluid replacement. To accomplish this, techniques provide for stored carbon dioxide to be used in the process. Carbon dioxide may be stored in an underground location prior to use in the methods described.

In embodiments, two trapping mechanisms may be used for the underground storage of carbon dioxide. In one non-limiting embodiment, structural trapping may be used by identifying strong lithologic and stress barriers that exist in fracturing, stimulation, and intervention candidates. In a second embodiment, residual and/or hysteresis trapping properties of the geological stratum, as they pertain to carbon dioxide, can be used.

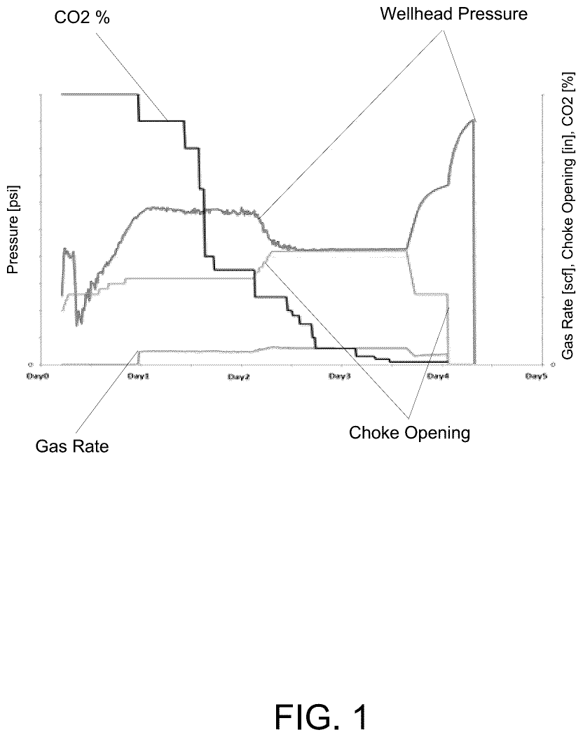

Referring to FIG. 1, a well is disclosed. The well has been put into a production mode immediately after fracturing. This phase is defined as the fracture cleanup or fracturing potential evaluation phase. FIG. 1 shows the evolution of carbon dioxide production, and it can be seen that in less than four days the carbon dioxide values drop to approximately zero.

Based on data analysis for FIG. 1, the post-fracturing carbon dioxide production is only about five to ten percent of what is pumped into the wellbore during the fracturing treatment. This analysis does not imply that ninety percent of carbon dioxide has been stored and that certain fractions of carbon dioxide are produced in the lifecycle of the well. Based on the irreducible saturation of carbon dioxide during dynamic saturation changes in the production phase, one hundred percent of pumped carbon dioxide will not be produced from the wellbore. In this instance, data supports the physical concept of residual trapping of carbon dioxide. As can be understood, the larger the amount of residual trapping of carbon dioxide, the more beneficial the ultimate results are for the wellbore when long term/permanent storage is required. Likewise, if storage is to be performed on a short term/non-permanent storage basis, the less likely the candidate well is, as the residual carbon dioxide storage may accept and retain larger amounts of carbon dioxide.

In example embodiments, it may be understood about the variability of wellbores to residually store carbon dioxide and when such residual storage may be an economic benefit and when it may relate to an economic loss. Wellbores and wellsites are located all over the world. In some instances, the locations are very remote to population centers, while in other locations, the locations may be collocated with population centers. In the instance where a wellbore has little to no residual carbon dioxide retention, such wellbores are particularly useful in locations that have industrial production facilities.

Certain industrial and commercial activities require large amounts of carbon dioxide for beneficial use. Beneficial uses include, but are not limited to, refrigeration systems, chemical production, soft drink/carbonated drink manufacturing, and welding systems. The chemical industry, in particular, may use exceptionally large amounts of carbon dioxide. It would therefore be beneficial to have a wellbore that stores carbon dioxide for long periods of time without residual capture in such locations. A low cost and efficient storage benefit would be gained and transportation of carbon dioxide may be avoided. The ultimate cost of products produced by the chemical plant, therefore, would be positively affected. A wellbore with a high residual retention would not be advantageous as the carbon dioxide placed into the well would be lost to the stratum surrounding the wellbore.

In a similar fashion, if a wellbore is located in a very remote location and large amounts of carbon dioxide are sought to be permanently stored, a wellbore with high residual carbon dioxide retention would be much more beneficial than a wellbore that would have little to no carbon dioxide retention capabilities. As regulations on carbon dioxide retention are generated by regulating authorities world-wide, many opportunities exist for beneficial and economic storage of carbon dioxide. Provision of carbon dioxide to these long-term storage wells may be directly from industry or from a plant specifically created to remove carbon dioxide directly from the atmosphere. Current projections from scientists forecast that carbon dioxide long term storage and retention will increase significantly during the upcoming decades. Fortunately, many wellbores in remote locations provide geological advantages for such storage. Since the number of abandoned wellsites is very large after hydrocarbon development for the last one hundred years, successful candidates for such long-term storage are large. As a result, it is not whether a specific wellsite is advantageous to use, but rather which wellsite of numerous wellsites would provide the best long term storage options. Such an environmental needs coupled with existing applicable sites provides large opportunities for economic return for such long-term sequestration.

Through aspects of the disclosure, certain wellbore functions can become carbon neutral or even carbon negative. If the carbon flowback capabilities of the geological stratum can be correctly identified or even modified, then amounts of carbon sequestration can be quantified. When such quantification can be performed, carbon sequestration can become a primary physical purpose for the wellsites utilizing this technology. In certain embodiments, formation of the wellbore or wellsite, can even utilize carbon dioxide in the formation process of the wellbore. In such instances, hydrocarbons may be removed from the wellsite for beneficial use by industry. A primary purpose of the wellsite will also be the long-term sequestration of carbon dioxide. Thus, for owners of such wellbores, two different economic streams may be present, whereas in conventional wells, only hydrocarbon removal is economically important.

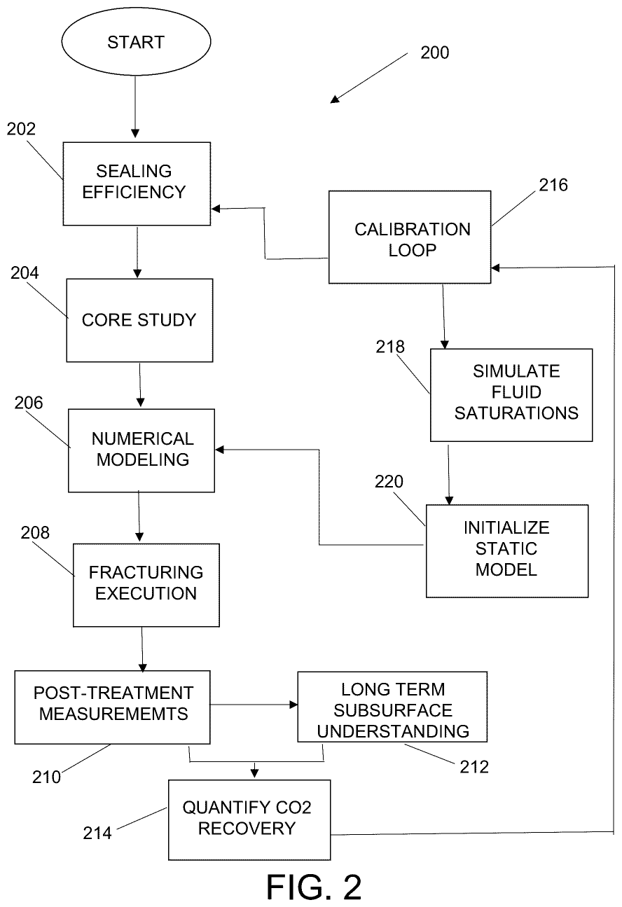

In embodiments, hydraulic fracturing and stimulation can become carbon neutral or even carbon negative by utilizing the potential to reduce carbon dioxide flowback after fracturing. One of the challenges pertaining to this objective is to demonstrate the ability of the wellbore to be able to store carbon dioxide after fracturing is done. This challenge can be systematically addressed with the method shown in FIG. 2. Referring to FIG. 2, at 202, the method starts with calculating the sealing efficiency of the caprock by all typical measurements required through characterization to estimate the structural trapping. At 204, the method proceeds with core tests that are conducted to study the relative permeability behavior of carbon dioxide. The relative permeability for fracturing filtrate, carbon dioxide and reservoir fluids can be quantified in the core study.

At 206, the method continues with the results of the core experiments being input to production flow simulation with a numerical model. The setup for the post-fracturing simulation can be populated with a dynamic fluid saturation simulation prepared upstream of this step. The model can be initialized with end of fracturing treatment saturations along with the fracture modeled (explicitly or numerically simulated) in the reservoir grid. This will conclude the design and preparation phase and will allow the design engineer to tailor/optimize the design. At 208, fracture execution may be initiated within the wellbore. The fracture execution is performed per the numerical modeling performed at 206. After the execution of the treatment on wellsite in 208, post-treatment measurements are performed at 210. In some embodiments, the execution of the post-treatment measurements is important for a pilot phase. In embodiments, measurements can be made with multiphase flowmeters, venturi correlations, or inline carbon dioxide sensors to measure and track cumulative carbon dioxide recovery/storage.

The method may also provide that, at 212, long term subsurface understanding may be performed. In some embodiments, these measurements are performed using a monitoring well and distributed sensing techniques to model long-term carbon dioxide plumes. The post-fracturing and long-term measurements data can be used to quantify carbon dioxide recovery/storage and be fed back to the numerical engines, at 206, for calibration. Once the static reservoir model is calibrated with real data, the carbon dioxide storage estimates can be upscaled to the assets.

Tests may be conducted, at 214 to be able to quantify the amount of carbon dioxide recovery, as necessary. Information obtained from 214 may be used to perform a calibration loop at 216, where, at 218, fluid saturations are simulated during fracturing with numerical modeling. Following 218, a static model may be initialized with post-fracturing fluid saturations, for example fracturing filtrate and carbon dioxide reservoir fluids. After 218, the method may loop back to 206. If simulation of fluid saturations is not necessary at 218, the method may loop back to 202.

Applications of the methods described herein are numerous. Wellbores that are created on land or at sea may be potential candidates for the methods and systems described herein. The method may also be used in conventional, tight gas/oil fields and wells. Further applications may be extended to geothermal and unconventional formations. Different materials may be added to the overall final fluid packages delivered to the downhole environment in order to increase or decrease the amount of carbon dioxide retained by the geological stratum. These materials may include proppants, acids, foams, energized treatments, sand control systems, or water control systems, in non-limiting embodiments. Applications of the methods described may be used in wellbore cleanout operations and plug milling/plug drill out operations. Applications may also be used in wellbore displacement operations and pump down during perforating activities. Other potential embodiments include use with perforating operations with abrasive materials and other intervention techniques where pumping fluids downhole is required. Applications may also be used with different conveyance types such as, coiled tubing, coiled tubing with fiber optics, wireline cable, wireline cable with fiber optics, and slickline.

Different types of wellbores may also use the methods and apparatus described herein. In embodiments, vertical, deviated, and horizontal wells may be treated with the methods, as well as, cased hole, open hole, open hole with fracturing sleeves, and isolation packers, and pre-perforated liners. Embodiments may be used in clastic, carbonate, and non-metamorphic (e.g. volcanic rock) geologic sequences.

In embodiments, the optimization of the method may be performed based upon use of synthetic datasets. In such embodiments, high quality data sets obtained from laboratory tests or field tests may be used to train artificial intelligence or predictive programs to enable quick selection of optimized solutions. In such embodiments, different features may be emphasized. For example, it may be desired to permanently store carbon dioxide within the wellbore; therefore, it is desired to reduce carbon dioxide recovery. In such embodiments, laboratory tests may be used to result in reduced carbon dioxide recovery. The embodiments will not be limited to reduced carbon dioxide recovery. In another such example, it may be desired to increase carbon dioxide draws from a wellbore. Such examples are possible where a beneficial use of carbon dioxide by industry is available. As carbon dioxide is used in many applications, it may be advantageous to use the captured carbon dioxide, thereby obviating the need to produce carbon dioxide through a manufacturing process.

In embodiments, the method steps described above, may be performed through a computer system actuating different equipment connected to the computer. In embodiments, the method described can be coded into a set of instructions, readable by computer, to achieve results. To this end, a non-volatile memory may be used to store the set of instructions to be executed. Example embodiments; therefore, include methods performed by a computer or computer system. Such computers or computer systems may use artificial intelligence for aid in operations and selection of correct method steps. In embodiments, the set of instructions may be placed on a universal serial bus device, a computer hard drive, a solid-state memory system, an internet enabled computer, and/or a cloud computing device.

Example embodiments of the claims are described next. The example embodiments disclosed should not be considered limiting. In one example embodiment, a method for carbon dioxide sequestration in a wellsite located within a geological stratum is disclosed. The method may comprise calculating a sealing efficiency of a geological stratum for which the carbon dioxide will be stored. The method may further comprise evaluating relative permeability behavior of carbon dioxide of the geological stratum. The method may further comprise performing a numerical modeling of a reservoir and the geological stratum for at least one of a hydraulic fracturing of the wellsite, a stimulation of the wellsite, and an intervention of the wellsite. The method may further comprise obtaining results that are optimized from the numerical modeling. The method may further comprise, based upon the results from the optimized numerical modeling, conducting the at least one of the hydraulic fracturing of the wellsite, the stimulation of the wellsite, and the intervention of the wellsite.

In another example embodiment, the method may further comprise determining an amount of flowback of carbon dioxide after the at least one of the fracturing, the stimulation, and the intervention.

In another example embodiment, the method may be performed wherein the determining of the amount of flowback of the carbon dioxide is performed with one of carbon dioxide analyzers, microseismic monitors, and flowmeters placed within the wellbore.

In another example embodiment, the method may further comprise performing a long-term evaluation of a carbon dioxide plume in the geological stratum.

In another example embodiment, the method may further comprise performing a calibration of the numerical modeling.

In another example embodiment, the method may further comprise simulating fluid saturation levels in the geological stratum during the calibration.

In another example embodiment, the method may further comprise initializing a static model with post-fracturing fluid saturations and performing calculations on the static model to produce results, wherein the results are used as inputs into the numerical modeling.

In another example embodiment of the disclosure, an article of manufacture having a non-volatile memory is disclosed. In this embodiment, the non-volatile memory is configured to store a list of method instructions to be read by a computing device and wherein the computing device is configured to enable actions to control a physical system, the physical system placed at a wellsite to be used for carbon dioxide sequestration within a geological stratum. The method recited may comprise calculating a sealing efficiency of a geological stratum for which the carbon dioxide will be stored and evaluating at least one of a carbon dioxide drainage and an imbibition behavior of the geological stratum. The method may further comprise performing a numerical modeling of the wellsite and the geological stratum for at least one of a hydraulic fracturing of the wellsite, a stimulation of the wellsite, and an intervention of the wellsite. The method may further comprise obtaining results that are optimized from the numerical modeling.

In another example embodiment of the disclosure, the article of manufacture may be configured wherein the article of manufacture is one of a universal serial bus device, a solid-state memory device, and a computer hard disk.

In another example embodiment, a method for carbon dioxide sequestration in a wellsite located within a geological stratum is disclosed. The method may comprise calculating a sealing efficiency of a geological stratum for which the carbon dioxide will be stored. The method may also comprise evaluating at least one of a carbon dioxide drainage and an imbibition behavior of the geological stratum. The method may also comprise performing a numerical modeling of the wellsite and the geological stratum for a hydraulic fracturing of the wellsite. The method may also comprise obtaining results that are optimized from the numerical modeling. The method may also comprise, based upon the results from the optimized numerical modeling, conducting the hydraulic fracturing of the wellsite, wherein carbon dioxide is used in the hydraulic fracturing. The method may also comprise monitoring the wellsite for leakage of carbon dioxide used in the hydraulic fracturing.

In another example embodiment, the method may be performed wherein the carbon dioxide is the only fluid used to conduct the hydraulic fracturing.

In another example embodiment, the method may be performed wherein the monitoring at the wellsite includes at least one of an up-hole carbon dioxide monitor, a downhole carbon dioxide monitor, and a microseismic monitor.

In another example embodiment, the method may be performed wherein the wellsite is placed in a sandstone formation.

In another example embodiment, the method may be performed wherein the monitoring of the wellsite for leakage includes modeling plumes of carbon dioxide subsurface.

In another example embodiment, the method may be performed wherein the numerical modeling is performed by at least one of a cloud-based computer and an internet connected computer.

In another example embodiment, the method may be performed wherein the numerical modeling is performed, at least in part, by an artificial intelligence system.

In another example embodiment, the method may be performed wherein the artificial intelligence system is trained using synthetic datasets.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method for carbon dioxide sequestration in a wellsite located within a geological stratum, comprising:
calculating a sealing efficiency of a geological stratum for which the carbon dioxide will be stored;
evaluating relative permeability behavior of the carbon dioxide for the geological stratum;
performing a numerical modeling of a reservoir and the geological stratum for at least one of a hydraulic fracturing of the wellsite, a stimulation of the wellsite, and an intervention of the wellsite;
obtaining results that are optimized from the numerical modeling; and
based upon the results from the optimized numerical modeling, conducting with the carbon dioxide, at least one of the hydraulic fracturing of the wellsite, the stimulation of the wellsite, and the intervention of the wellsite.

2. The method according to claim 1, further comprising determining an amount of flowback of carbon dioxide after the at least one of the fracturing, the stimulation, and the intervention.

3. The method according to claim 2, wherein the determining of the amount of flowback of the carbon dioxide is performed with one of carbon dioxide analyzers, microseismic monitors, and flowmeters placed within the wellbore.

4. The method according to claim 2, further comprising performing a long-term evaluation of a carbon dioxide plume in the geological stratum.

5. The method according to claim 1, further comprising performing a calibration of the numerical modeling.

6. The method according to claim 5, further comprising simulating fluid saturation levels in the geological stratum during the calibration.

7. The method according to claim 6, further comprising initializing a static model with post-fracturing fluid saturations and performing calculations on the static model to produce results, wherein the produced results are used as inputs into the numerical modeling.

8. The method according to claim 1, wherein carbon dioxide is used, at least in part, for fracturing the geological stratum.

9. An article of manufacture having a non-volatile memory, the non-volatile memory configured to store a list of method instructions to be read by a computing device and wherein the computing device is configured to enable actions to control a physical system, the physical system placed at a wellsite to be used for carbon dioxide sequestration within a geological stratum, the method comprising:
calculating a sealing efficiency of a geological stratum for which the carbon dioxide will be stored;
evaluating at least one of a carbon dioxide drainage and an imbibition behavior of the geological stratum;
performing a numerical modeling of the wellsite and the geological stratum for at least one of a hydraulic fracturing of the wellsite, a stimulation of the wellsite, and an intervention of the wellsite; and
obtaining results that are optimized from the numerical modeling.

10. The article of manufacture according to claim 9, wherein the article of manufacture is one of a universal serial bus device, a solid-state memory device, and a computer hard disk.

11. A method for carbon dioxide sequestration in a wellsite located within a geological stratum, comprising:
calculating a sealing efficiency of a geological stratum for which the carbon dioxide will be stored;
evaluating at least one of a carbon dioxide drainage and an imbibition behavior of the geological stratum;
performing a numerical modeling of the wellsite and the geological stratum for a hydraulic fracturing of the wellsite;
obtaining results that are optimized from the numerical modeling;
based upon the results from the optimized numerical modeling, conducting the hydraulic fracturing of the wellsite, wherein carbon dioxide is used in the hydraulic fracturing; and
monitoring the wellsite for leakage of carbon dioxide used in the hydraulic fracturing.

12. The method according to claim 11, wherein the carbon dioxide is the only fluid used to conduct the hydraulic fracturing.

13. The method according to claim 11, wherein the monitoring at the wellsite includes at least one of an up-hole carbon dioxide monitor, a downhole carbon dioxide monitor, and a microseismic monitor.

14. The method according to claim 11, wherein the wellsite is placed in a sandstone formation.

15. The method according to claim 11, wherein the monitoring of the wellsite for leakage includes modeling plumes of carbon dioxide subsurface.

16. The method according to claim 11, wherein the numerical modeling is performed by at least one of a cloud-based computer and an internet connected computer.

17. The method according to claim 11, wherein the numerical modeling is performed, at least in part, by an artificial intelligence system.

18. The method according to claim 17, wherein the artificial intelligence system is trained using synthetic datasets.
